(19) United States
(12) Patent Application Publication
(10) Pub. No.: US 2024/0362462 A1
(43) Pub. Date: Oct. 31, 2024

(54) SYSTEMS AND METHODS OF MACHINE LEARNING-BASED SAMPLE CLASSIFIERS FOR PHYSICAL SAMPLES

(71) Applicant: ThinkCyte K.K., Tokyo (JP)

(72) Inventors: Hirofumi Nakayama, Tokyo (JP); Ryo Tamoto, Tokyo (JP); Yuichi Yanagihashi, Tokyo (JP)

(73) Assignee: ThinkCyte K.K., Tokyo (JP)

(21) Appl. No.: 18/648,216

(22) Filed: Apr. 26, 2024

Related U.S. Application Data
(60) Provisional application No. 63/462,713, filed on Apr. 28, 2023.

(51) Int. Cl. G06N 3/0455; G06N 3/09

(52) U.S. Cl. CPC G06N 3/0455; G06N 3/09

(57) ABSTRACT

Systems and methods are provided to implement classification of objects, based on sensor data regarding the objects, without labels assigned to the sensor data. A system can include one or more processors. The one or more processors can retrieve sensor data regarding an object. The one or more processors can apply the sensor data as input to a classification model to cause the classification model to determine a classification of the object. The classification model can be configured based on training data that includes a plurality of clusters generated by dimensionality reduction of example data regarding example objects. At least one cluster of the plurality of clusters can be associated with the classification. The one or more processors can output the classification of the object.

### CROSS-REFERENCE TO RELATED APPLICATIONS

The present application claims the benefit of and priority to U.S. Provisional Application No. 63/462,713, filed Apr. 28, 2023, the disclosure of which is incorporated herein by reference in its entirety.

### FIELD

This application relates generally to the field of machine learning-based classifiers, and more particularly to machine learning-based physical sample classifiers.

### BACKGROUND

Classification models can be used to assign class information to samples, such as class information indicative of one or more characteristics or identifiers of samples. Class information can be assigned based on processing of sensor data regarding the samples.

### SUMMARY

The performance of classification models can be limited by the quality of the training data used to configure the classification models. The present disclosure addresses this and other aspects.

At least one aspect relates to a system. The system can include one or more processors. The one or more processors can retrieve sensor data regarding an object. The one or more processors can apply the sensor data as input to a classification model to cause the classification model to determine a classification of the object. The classification model can be configured based on training data that includes a plurality of clusters generated by dimensionality reduction of example data regarding example objects. At least one cluster of the plurality of clusters can be associated with the classification. The one or more processors can output the classification of the object.

At least one aspect relates to a method. The method can include retrieving, by one or more processors, sensor data regarding an object. The method can include applying, by one or more processors, the sensor data as input to a classification model to cause the classification model to determine a classification of the object. The classification model can be configured based on training data that includes a plurality of clusters generated by dimensionality reduction of example data regarding example objects. At least one cluster of the plurality of clusters can be associated with the classification. The method can include outputting, by the one or more processors, the classification of the object.

At least one aspect relates to a system. The system can include a flow cytometer configured to direct a fluid flow that includes an object through a field of view of a photosensor/photodetector, and to cause the photosensor/photodetector to detect sensor data regarding the object. The system can include one or more processors. The one or more processors can apply the sensor data as input to a classification model to cause the classification model to detect a classification of the object. The one or more processors can be configured based on training data that includes a plurality of clusters generated by dimensionality reduction of example data regarding example cells. At least one cluster of the plurality of clusters can be associated with the classification. The one or more processors can output the classification.

At least one aspect relates to a method. The method can include directing, by a flow cytometer, an object through a field of view of a photosensor/photodetector. The method can include causing the photosensor/photodetector to detect sensor data regarding the object. The method can include applying, by one or more processors, the sensor data as an input to a classification model to cause the classification model to detect a classification of the object. The method can include outputting the classification.

At least one aspect relates to a system. The system can include one or more processors. The one or more processors can receive a plurality of sensor data representations of a plurality of objects, wherein the plurality of objects comprise at least one of cellular material, nucleic acid material, biological material, or chemical material, or any combination thereof. The one or more processors can perform dimensionality reduction of the plurality of sensor data representations to assign each object of the plurality of objects to a corresponding cluster of a plurality of clusters. The one or more processors can assign an identifier of a type of a given object of the plurality of objects to the corresponding cluster of the plurality of clusters to which the given object is assigned. The one or more processors can configure a classification model based on the plurality of clusters and the identifier of the type.

At least one aspect relates to a method. The method can include receiving, by one or more processors, a plurality of sensor data representations of a plurality of objects, wherein the plurality of objects comprise at least one of cellular material, nucleic acid material, biological material, or chemical material. The method can include performing, by the one or more processors, perform dimensionality reduction of the plurality of sensor data representations to assign each object of the plurality of objects to a corresponding cluster of a plurality of clusters. The method can include assigning, by the one or more processors, an identifier of a type of a given object of the plurality of objects to the corresponding cluster of the plurality of clusters to which the given object is assigned. The method can include configuring, by the one or more processors, a classification model based on the plurality of clusters and the identifier of the type.

At least one aspect relates to a method. The method can include (a) feeding (i.e., inputting) time-series electrical signals of an observed object into at least one dimensionality reduction method to extract at least one feature of the observed object from the time-series electrical signals. The method can include (b) comparing a distribution of the at least one feature of the observed objects extracted by at least one dimensionality reduction method with the distribution of a subset of observed objects. The method can include (c) setting at least one gate to differentiate digitally the time-series electrical signals of the subset of observed objects among the time-series electrical signals of the observed objects fed in (a). The method can include (d) performing a machine learning to create a classification model using the time-series electrical signals, wherein the time-series electrical signals of the target objects are digitally differentiated among the time-series electrical signals obtained from the observed objects based on the at least one the gate set in (c). The method can include (e) classifying the target objects among the observed objects using the time-series electrical signals of the observed objects based on the classification model, wherein the time-series electrical signals of the observed objects are obtained based on at least one electromagnetic wave measured by ghost cytometry without labeling to identify the observed objects.

At least one aspect relates to a method. The method can include (a) feeding time-series electrical signals of observed objects into at least one clustering process (method) to categorize the time-series electrical signals into multiple clusters. The method can include (b) identifying at least one cluster of interest in which each of observed objects belonging to a subset of observed objects are included using at least one feature of the observed objects. The method can include (c) performing machine learning to create a classification model using the time-series electrical signals obtained without any labeling to identify the observed objects, wherein the time-series electrical signals of the target objects are digitally differentiated by the at least one cluster of interest identified in (b) among the time-series electrical signals of the observed objects. The method can include (d) classifying the target objects among the observed objects using the time-series electrical signals of the observed objects based on the classification model, wherein the time-series electrical signals of the observed objects are obtained based on at least one electromagnetic wave measured by ghost cytometry without any labeling to identify the observed objects.

In some implementations, one or more methods includes sorting the target objects among the observed objects without generation of an image after analyzing the time-series electrical signals. In some implementations, one or more methods includes identifying the observed objects included in the subset by the information provided by a label artificially given to the observed objects. The dimensionality reduction method can be one of an autoencoder, Uniform Manifold Approximation and Projection (UMAP), principal component analysis (PCA), or t-distributed Stochastic Neighbor Embedding (t-SNE) technique. In some implementations, the clustering method used is one of k-means clustering, density-based spatial clustering of applications with noise (DBSCAN), hierarchical clustering, and spectral clustering. In some implementations, the classification model created by performing machine learning is created using one of a support vector machine (SVM), logistic regression, or a decision tree. The target objects can be the observed objects included in the subset of observed objects.

The at least one electromagnetic wave measured by ghost cytometry is obtained by (i) illuminating one or more observed objects flowing through at least one flow path by light with an illumination pattern, and (ii) receiving, by a sensor, electromagnetic waves irradiated from the observed objects illuminated by the illumination pattern. The illumination pattern can be a structured illumination pattern.

At least one aspect relates to a method. The method can include (a) feeding time-series electrical signals of the observed objects into at least one dimensionality reduction method to extract at least one feature of the observed object from the time-series electrical signals. The method can include (b) comparing the distribution of the at least one feature of the observed objects extracted by at least one dimensionality reduction method with the distribution of a subset of observed objects. The method can include (c) setting at least one gate to differentiate digitally the time-series electrical signals of the subset of observed objects among the time-series electrical signals of the observed objects fed in (a). The method can include (d) performing machine learning to create a classification model using the time-series electrical signals, wherein the time-series electrical signals of the target objects are digitally differentiated among the time-series electrical signals obtained from the observed objects based on the at least one the gate set in (c). The method can include the time-series electrical signals of the observed objects being obtained based on at least one electromagnetic wave measured by ghost cytometry without any labeling to identify the observed objects.

At least one aspect relates to a method. The method can include (a) feeding the time-series electrical signals of the observed objects into at least one clustering method to categorize the time-series electrical signals into multiple clusters. The method can include (b) identifying at least one cluster of interest in which each of observed objects belonging to a subset of observed objects are included using at least one feature of the observed objects. The method can include (c) performing machine learning to create a classification model using the time-series electrical signals obtained without any labeling to identify the observed objects, wherein the time-series electrical signals of the target objects are digitally differentiated by the at least one cluster of interest identified in (b) among the time-series electrical signals of the observed objects. The method can include (d) classifying the target objects among the observed objects using the time-series electrical signals of the observed objects based on the classification model. The time-series electrical signals of the observed objects can be obtained based on at least one electromagnetic wave measured by ghost cytometry without any labeling to identify the observed objects.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example of a sensor system to perform classification of objects.

FIG. 2 depicts an example of a flow cytometer to detect information regarding objects.

FIG. 3 depicts an example of a training system to train a classification model for classification of objects.

FIG. 4 depicts an example of a process for training a classification model using dimensionality reduction.

FIG. 5 depicts an example of a process for training a classification model using clustering.

FIGS. 6A, 6B and 6C depict an example of charts of performance of a classification model for object sorting.

FIGS. 7A, 7B, 7C, 7D and 7E depict an example of charts of performance of a classification model for blood cell sorting.

FIGS. 8A, 8B, 8C, 8D and 8E depict an example of charts of performance of a classification model for donor cell sample sorting.

FIG. 9 depicts an example of a method for training a classification model for object classification.

FIG. 10 depicts an example of a method for deploying a classification model for object classification.

FIG. 11 depicts an example of a label-free cellular sorter utilizing ghost cytometry.

FIG. 12 shows an example of computer system that is programmed or otherwise configured to implement methods and systems of the present disclosure.

### DETAILED DESCRIPTION

Following below are more detailed descriptions of various concepts related to, and implementations of systems and methods of machine learning-based physical, biological, and/or chemical sample classifiers. While various implementations described herein relate to configuring classifiers for processing cell data from flow cytometers, the system and methods described herein can be implemented for any of various classifiers. In particular, the classifiers can relate to, but are not limited to, classifiers for cellular material from one or more cells, protein material, DNA material, RNA material, biological material, chemical material, or any combination thereof. The cellular material can include material from one or more cells from a population of cells, including peptides, polypeptides or proteins, for example.

Classifiers, including machine learning-based classification models, are useful for detecting useful information regarding objects, such as samples of materials, such as samples of cells, biological materials, and/or chemical materials. For example, classification models can be used to detect class information such as types of cells and/or features of cells. The classification models can be trained by being provided training data that includes data regarding the objects (e.g., sensor data) and labels corresponding to the class information. Examples of classification are set forth in U.S. Pat. No. 11,314,994, issued on Apr. 26, 2022, and U.S. Patent Application Publication No. 2022/0317020, published Jan. 18, 2024, the entire contents of each of which are incorporated herein by reference, including for the classification target techniques set forth therein.

For example, some classification models rely on artificial labelling such as molecular marker tagging and/or staining of samples, which can then be detected by sensors (e.g., flow cytometers) and/or from processing of outputs from the sensors. The sensor outputs can thus be used for training of the classification models, where the molecular markers can act as labels for the sensor outputs that the classification models can use for learning to classify the samples. Examples of learning are set forth in U.S. Patent Application Publication No. 2020/0027020, published Jan. 23, 2020, and U.S. Pat. No. 11,643,649, issued on May 9, 2023, the entire contents of each of which are incorporated herein by reference, including for the learning techniques set forth therein.

However, reliance on labeling can increase the material and/or data requirements for training the classification models, such as by requiring the use of molecular markers and/or sufficient amounts of the target objects to be classified. In addition, the use of molecular markers for training can limit the ability of the classification models to effectively classify objects and/or detect classes of objects that are not directly associated with the information represented by the molecular markers. For example, cells can have unknown molecular markers and/or the molecular markers for a given cell or subset of cells may not be specific enough to effectively train classification models. As such, it can be difficult to create a classification model which can precisely predict a specific cell type (target cell) among other cell types in the test sample if the target cells cannot be tagged with known molecular marker. Such factors can similarly make it challenging for creating classification models for physical sample classification, such as for various chemical and/or biological samples.

Systems and methods in accordance with the present disclosure can facilitate training and operation of classification models with reduced use or without use of labeling corresponding to the classes. For example, the classification model can be trained without providing artificial labels to the objects (e.g., cells), which can reduce the requirements for training of the models and make the models for effective for predicting classes beyond those directly related to label information. This can include training the classification model based on clusters and/or gates detected from dimensionality reduction of unlabeled data. The classification model can in turn be used for classifying and sorting of target objects amongst observed objects. The classification model can be implemented for real-time (or near real-time operation) on sensor data, which can facilitate high throughput processing of sensor data, e.g., high throughput classification of objects. The classification model can be implemented on a field-programmable gate array (FGPA) hardware device to facilitate effective real-time operation.

For example, time-series electrical signals obtained from electromagnetic waves, such as waveforms obtained without image production from the waveforms (e.g., ghost motion imaging (GMI) waveforms obtained by ghost cytometry) can be applied to at least one unsupervised machine learning model, based on which the least one unsupervised machine learning model can set at least one gate or cluster to differentiate the time-series electrical signals of a subset of observed cells among the time-series electrical signals obtained from the observed cells. Ghost cytometry can be used to produce an image of an object without a spatially resolving detector. In particular, ghost cytometry can be performed to achieve cell classification and/or selective sorting based on cell morphology without reliance on a specific biomarker. Examples of ghost cytometry are set forth, e.g., in U.S. Pat. No. 11,788,948, issued on Oct. 17, 2023, the entire contents of which are incorporated herein by reference, including for the ghost cytometry systems and methods set forth therein. Further, examples of electromagnetic wave generation are found, for example, in U.S. Pat. No. 10,904,415 issued on Jan. 26, 2021, and U.S. Pat. No. 11,549,880, issued on Jan. 10, 2023, the entire contents of each of which are incorporated herein by reference, including for the electromagnetic wave generation and imaging techniques therein. Thereafter, the time-series electrical signals of the target cells obtained from the test sample can be digitally differentiated using the at least one gate or one cluster for the prediction of a target cells among the observed cells. Further, learning of a classification model is performed using the digitally differentiated time-series electrical signals as a set of training data without giving artificial labeling to the observed cells. As such, the classification model can accurately predict a specific cell type (e.g., target cells) among other cell types in the test sample in the case that the target cells cannot be obtained in a sufficient quantity for the training of the classification model. The classification model can predict target cells among other cells in the test sample even in the case that no molecular marker of the target cells is identified for isolating the cells.

In some implementations, a system includes one or more processors, which can be at least partially implemented by hardware of a sensor, such as a flow cytometer, or can be communicably coupled with the sensor. The one or more processors can retrieve sensor data regarding an object. The object can include a cell, a biological sample, a chemical sample, or various combinations thereof. The sensor data can be from a flow cytometer. For example, the sensor data can include or be representative of a waveform, such as a time-series electrical signal representative of an electromagnetic wave detected regarding the object. In particular, the electrical signal is representative of an electromagnetic wave corresponding to the object or objects (e.g., cellular material as described above). The one or more processors can apply the sensor data as input to a classification model to determine a classification of the object. The classification model can be configured with training data that includes a plurality of clusters generated by dimensionality reduction of example data regarding example objects, where at least one cluster of the plurality of clusters is associated with the classification. At least one other cluster of the plurality of clusters can be unassociated (i.e., not associated) with the classification. The dimensionality reduction can include any one or more of clustering, autoencoding, uniform manifold approximation and projection (UMAP), principal component analysis (PCA), and/or t-distributed stochastic neighbor embedding (t-SNE) operations. The classification model can include, for example, at least one of a support vector machine (SVM), a regression function (e.g., logistic regression function), or a decision tree. The one or more processors output the classification, such as to output the classification as a cell type of a cell. By incorporating various features described herein, systems and methods in accordance with the present disclosure can achieve higher performance in the classification of objects such as cellular material, nucleic acid material, biological samples, chemical samples, or various combinations thereof.

### Sensors for Object Data Detection

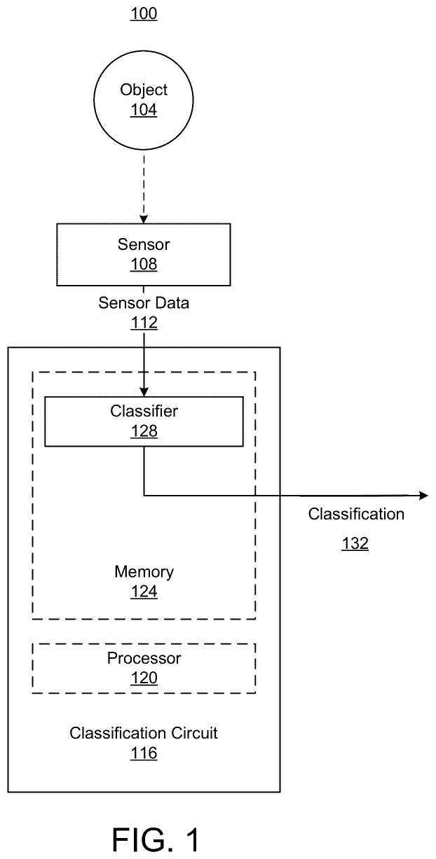

FIG. 1 depicts an example of a sensor system 100. The sensor system 100 can be used to detect sensor data regarding one or more objects 104. The objects 104 can include samples of physical materials, such as biological and/or chemical materials. For example, the objects 104 can include cellular material, nucleic acid material, biological material, chemical material, or any combination thereof.

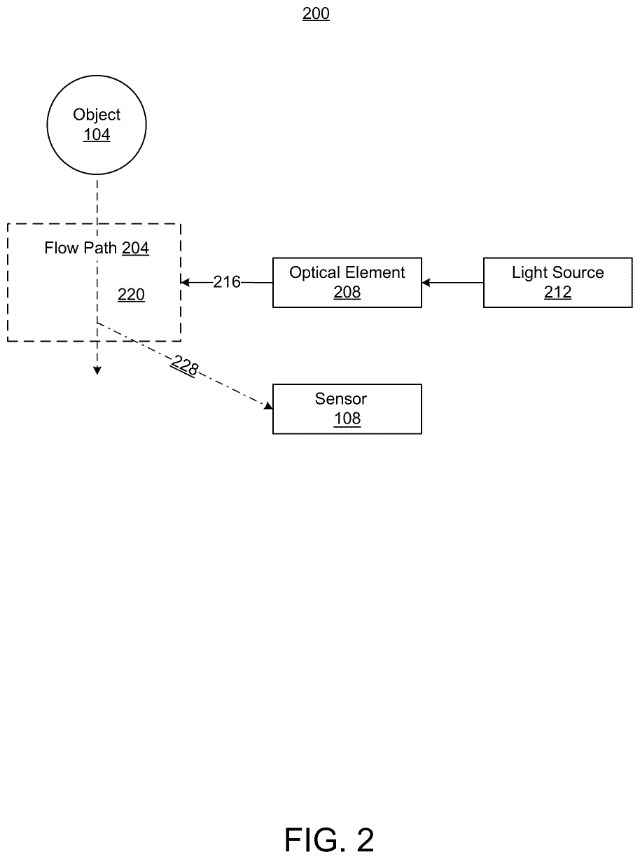

The sensor system 100 can include at least one sensor 108. The sensor 108 can include any of various sensors that can detect sensor data 112 regarding the one or more objects 104, and which can output the sensor data 112 (e.g., an electrical signal representative of the data, such as a waveform signal including morphological information of the object 104 (e.g., representative of an object type of the corresponding object 104) or a GMI waveform signal as described with reference to FIG. 2, e.g., a time-series electrical signal representative of an electromagnetic wave detected regarding a respective object 104). For example, the sensor 108 can generate and/or store a data structure that includes the sensor data 112, and which can include at least one of an identifier of the object 104, an identifier of the sensor 108, or a time point at which the sensor data 112 is detected. The sensor 108 can output the data structure, e.g., as an electrical signal, to one or more remote devices, including in a periodic manner (e.g., output each data structure individually), continuously, or in a batch arrangement.

The sensor 108 can include one or more photosensors/photodetectors such as photomultiplier tubes and/or one or more image capture devices. Photosensor/photodetectors, for example, can include a through-beam arrangement, a reflective arrangement, a laser-reflective arrangement, or a diffused arrangement. The photosensors/photodetectors of sensor 108 can include, for example, a photomultiplier tube device. The overall system including the sensor system 100 can be implemented as a flow cytometer system configured to perform ghost motion imaging. The ghost motion imaging can be performed for cell analysis and/or cell sorting. The flow cytometer may be a flow cytometer as set forth in U.S. Pat. No. 11,098,275, issued on Aug. 24, 2021, U.S. Pat. No. 11,630,293, issued on Apr. 18, 2023, U.S. Pat. No. 11,598,712, issued on Mar. 7, 2023, U.S. Patent Application Publication No. 2023/0012588, published Jan. 19, 2023, U.S. Patent Application Publication No. 2023/0039952 published Feb. 9, 2023, and U.S. Patent Application Publication No. 2023/0090631, published Jan. 18, 2024, the entire contents of each of which are incorporated herein, including for the flow cytometry systems and methods therein.

In some implementations, the at least one sensor 108 is provided in a flow cytometer system that can include at least one light source (e.g., a laser) that can output light towards a fluid flow in which the object 104 is provided and can include at least one detector to receive an output signal from scattering of the light signal by the object 104. The scattering (and thus the output signal) can represent one or more characteristics of the object 104, and can correspond, in some implementations, to a pattern of the light outputted by the light source. The characteristics may include, for example, morphological aspects or changes, as set forth, for example, in U.S. Patent Application Publication No. 2021/0310053, published on Oct. 7, 2021, the entire contents of which are incorporated herein by reference, including for the identification techniques set forth therein. The light pattern can be, for example, a light pattern as set forth in U.S. Pat. No. 10,761,011, issued on Sep. 1, 2020, the entire contents of which are incorporated herein by reference including for the imaging techniques set forth therein. The detector can generate the sensor data 112 for the flow cytometer to output as the electrical signal.

FIG. 2 depicts an example of a flow cytometer 200 of a flow cytometer system. The flow cytometer 200 can use light or certain light patterns for detecting information regarding objects, including for classification of objects, with or without generating images of the objects. For example, the flow cytometer 200 can generate waveforms or GMI waveforms, such as electromagnetic signals representative of one or more characteristics of the objects, without generating images of the objects. In some implementations, the flow cytometer can be operated in a mode to perform analysis of captured images of objects, such as for classification. In some implementations, the flow cytometer 200 is configured to perform fluorescent activated cell sorting (FACS) and/or operate in a FACS mode. In some implementations, one or more components of the flow cytometer 200 are implemented by the sensor system 100 (or vice versa).

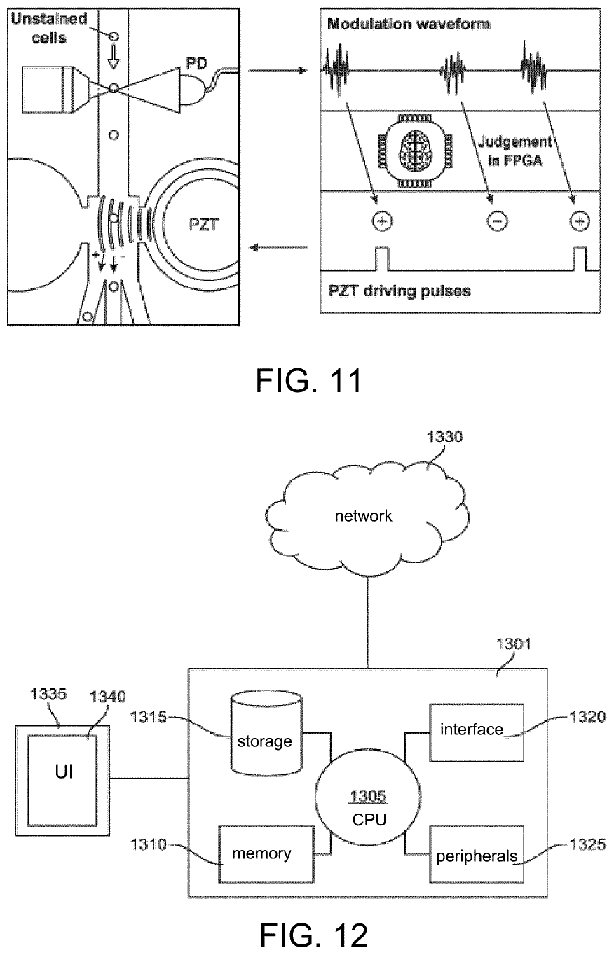

FIG. 11 depicts an example of a sorter (a sorting device) configured to carry out label-free sorting utilizing ghost cytometry. In some implementations, a field-programmable gate array (FPGA) is configured to implement a machine learning classifier to classify each cell passing by the photosensor/photodetector (PD). The cells can be unstained. The FPGA is configured to send pulses to a piezoelectric (PZT) actuator to actuate the actuator to move cells identified as cells of interest to an adjacent channel. More particularly, the modulation waveform is analyzed by the FPGA (e.g., the FPGA carries out a judgment to analyze the modulation waveform) and then provided to cause driving of the PZT actuator.

For example, the flow cytometer 200 can include at least one flow path 204. Fluid in which objects 104 are disposed can be flowed through the flow path 204 (e.g., by a pump or gravity), such as to be directed through a field of view of the sensor 108. The pump can be configured to supply fluid through a flow path in which the objects 104 are disposed.

The flow cytometer 200 can include at least one optical element 208. The optical element 208 can cause a pattern to be applied to light (e.g., from light source 212), such as a random pattern or a structured pattern or can change light from light source 212 into light having a certain pattern (e.g. uniform pattern or random pattern). The optical element 208 can include, for example, lenses, mirrors (e.g., micro mirrors), gratings, diffractive optical elements (DOEs), or various combinations thereof. The optical element 208 may be a cylindrical lens to focus the light from the light source 212.

The optical element 208 can be disposed along a light path 216 between the light source 212 and a region 220 in the flow path 204. The light source 212 can include, for example, a laser or a light emitting diode (LED) or an LED array, for example. The light source 212 can output light along the light path 216 to illuminate the objects 104 flowed through the flow path 204. The optical element can cause the light from the light source 212 to be patterned so that the objects 104 are illuminated in the region 220 with an illumination pattern (e.g., a structured and/or a random illumination pattern imparted by the optical element 208), such as for the flow cytometer 200 to operate in a structured light mode. In some embodiments, the illumination pattern is achieved by providing a glass diffuser in the form of a diffractive optical element (DOE). The DOE can be positioned with respect to the light source 212 to achieve the illumination pattern.

As noted above, the flow cytometer system can include the sensor 108 (e.g., a light-receiving unit; a light receiver or receptor). The sensor 108 can receive at least one electromagnetic wave 228 from reflection and/or scattering of the illumination pattern by the objects 104 in the flow path 204.

The sensor 108 can convert the electromagnetic wave into one or more electrical signals. For example, the sensor 108 can include one or more photodetectors to convert optical signals into electrical signals indicative of properties of the optical signals. The sensor 108 can output the electrical signals to represent a waveform, such as to represent amplitude over a period of time of the waveform, corresponding to the electromagnetic wave 228 from the objects 104. The electrical signals can be GMI waveforms (e.g., waveforms representative of the objects 104 without generation of an image of the objects).

Referring further to FIG. 1, the sensor system 100 can include a classification circuit 116, which can include one or more processors 120 and one or more memories 124. The one or more processors 120 can be a general purpose or specific purpose processors, an application specific integrated circuit (ASIC), one or more field programmable gate arrays (FPGAs), a group of processing components, or other suitable processing components. The processors 120 can execute computer code and/or instructions stored in the memories or received from other computer readable media (e.g., CDROM, network storage, a remote server, etc.). The processors 120 can be configured in various computer architectures, such as graphics processing units (GPUs), distributed computing architectures, cloud server architectures, client-server architectures, or various combinations thereof. One or more first processors 120 can be implemented by a first device, such as an edge device, and one or more second processors 120 can be implemented by a second device, such as a server or other device that is communicatively coupled with the first device. The one or more second processors may have different (e.g., greater) processor and/or memory resources than the one or more first processors. The memory 124 can include one or more devices (e.g., memory units, memory devices, storage devices, etc.) for storing data and/or computer code for completing and/or facilitating the various processes described in the present disclosure. The memories 124 can include random access memory (RAM), read-only memory (ROM), hard drive storage, temporary storage, non-volatile memory, flash memory, optical memory, or any other suitable memory for storing software objects and/or computer instructions. The memories 124 can include database components, object code components, script components, or any other type of information structure for supporting the various activities and information structures described in the present disclosure. The memories 124 can be communicably connected to the processors 120 and can include computer code for executing (e.g., by the processors 120) one or more processes described herein. The classification circuit 116 can be communicably coupled with various components of the system 100, such as the sensor 108, such as to retrieve sensor data regarding an object from the sensor 108, or from one or more data sources (e.g., data sources 304).

In some implementations, the classification circuit 116 is or includes a field programmable gate array (FPGA). For example, the classification circuit 116 can be an FPGA that includes (e.g., implements) at least a portion of the one or more processors 120 and memory 124 and/or the functions of the one or more processors 120 and memory 124. For example, the FPGA can execute the classifier 128, such as to execute the classifier 128 on sensor data 112 from a flow cytometer through which the one or more objects 104 (e.g., one or more cells) are flowed. In some implementations, it can be challenging for hardware devices to perform classification operations on sensor data regarding objects, such as sensor data represented by the electrical signals outputted by the sensor 108, with both sufficient classification performance (e.g., accuracy, precision, recall, and/or F1 score) and speed (e.g., to allow for real time or near-real time processing speed, such as to classify objects at a classification rate about equal to a flow rate of the objects being passed through the sensor 108 and/or a data rate of output from the sensor 108. By configuring the FPGA 116 to execute components of the sensor system 100, such as the classifier 128, the FPGA 116 can achieve enhanced target classification performance and speed, allowing for greater throughput of objects for observation and classification through the sensor system 100.

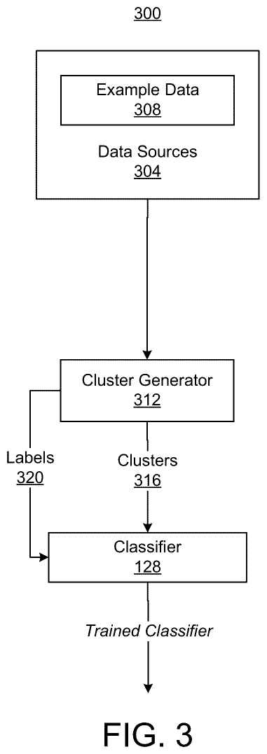

Referring further to FIG. 1, the classification circuit 116 can include at least one classifier 128. The classifier 128 can include one or more functions, rules, heuristics, policies, code, logic, machine learning models, algorithms, or various combinations thereof to perform operations including classification of objects 104 based on sensor data 112 regarding the objects 104. The classifier 128 can include one or more supervised machine learning models (e.g., as described with reference to FIG. 3) that can be trained to determine a classification 132 of a given object 104 based on the sensor data 112 regarding the given object 104, such as by having the sensor data 112 applied as input to the classifier 128. The classifier 128 can output a data signal representative of the classification 132. For example, the classifier 128 can generate the data signal to include the classification 132, and to include information regarding the object 104 represented by the sensor data 112, such as at least one of the identifiers of the object 104, the identifier of the sensor 108, or the time point at which the sensor data 112 is detected.

### Training Machine Learning-Based Classifiers

FIG. 3 depicts an example of a training system 300 (e.g., classifier training system). The classifier training system 300 can be used to configure (e.g., train, update, calibrate, perform supervised learning of) the one or more classifiers 128 described with reference to FIG. 1. In some implementations, one or more components of the training system 300 are implemented by the sensor system 100 (or vice versa). As described further herein, the classifier(s) 128 can be configured based on training data that includes a plurality of clusters generated by dimensionality reduction of example data (e.g., example data 308) regarding example objects, such as dimensionality reduction that generates clusters and/or processes the example data into a reduced dimensional space (e.g., UMAP, among other dimensionality reduction operations described herein), such as for assigning a gate to a region of the reduced dimensional space. For example, based on such configuration, during inference operation of the classifier(s) 128, the classifier(s) 128 can assign a classification to an object (e.g., represented by sensor data 112), where at least one cluster of the plurality of clusters is associated with the classification.

The training system 300 can include or be coupled with one or more data sources 304. The data sources 304 can be maintained by any of various entities, such as to be provided as part of, or remotely coupled with, any of various systems or devices described herein.

The data sources 304 can include example data 308. The example data 308 can include data regarding objects 104 (e.g., example objects) based on light reflected or scattered by the objects 104. The example data 308 can be analogous to the sensor data 112. For example, the example data 308 can include data outputted by sensors 108, such as GMI waveforms (e.g., time-series electrical signals representative of GMI waveforms obtained and/or outputted by the flow cytometer 200). The example data 308 can include images of the objects 104, such as cell images captured by an image captured device or cell images reconstructed with waveforms detected by sensors 108.

The example data 308 can include one or more identifiers of the objects 104 and/or a given sensor 108 that generates the data regarding the objects 104, such as an identifier of a subject (e.g., patient) from which a given object 104 is retrieved, or a condition of the subject or the object 104 (e.g., a pathology; whether the object 104 corresponds to a tumor and/or cancerous tissues). For example, the example data 308 can be a plurality of example data elements, each example data element including sensor data regarding a given object 104 and an identifier of the given object 104. The identifiers can represent types of the objects 104.

In some implementations, the example data 308 are not assigned labels (e.g., predetermined labels) of a classification for the example data 308. For example, the example data 308 may not be assigned any identifiers of cell types or molecular marker expression. For example, the example data 308 can correspond to data for which classification information is not available. In some implementations, at least some example data 308 is assigned labels, although the training system 300 may not use the assigned labels for at least some of the operations described further herein.

The training system 300 can perform training operations using various batches of example data 308. For example, the training system 300 can assign at least a first subset of the example data 308 to a first batch, e.g., a training batch, and a second subset of the example data 308 to a second batch, e.g., a test and/or validation batch. The training system 300 can assign the example data 308 to batches randomly, based on instructions for the assignments, and/or based on evaluation of statistical features of the batches (e.g., so that the training batch and test batch are relatively similar, i.e., substantially equivalent). The training system 300 can perform cluster generation and training of the classifier 128 using the training batch and can validate the performance of the trained classifier 128 using the test batch.

The training system 300 can include at least one cluster generator 312. The cluster generator 312 can include one or functions, rules, heuristics, policies, code, logic, machine learning models, algorithms, or various combinations thereof to perform operations including dimensionality reduction and/or clustering of example data 308, such as to generate clusters 316 (and/or to generate gates corresponding to the clusters 316). The cluster generator 312 can include a machine learning model configured to perform unsupervised learning on the generate clusters 316 and/or gates with respect to the example data 308 (e.g., to generate the plurality of clusters without the predetermined labels of the example data 308). For example, the cluster generator 312 can receive the example data 308 and can output clusters 316 indicative of example data 308 grouped according to features of the objects 104 as represented by the example data 308. The clusters 316 can correspond to different types (e.g., classes/classifications) of objects 104. For example, the cluster generator 312 can generate, based on the example data 308, a first cluster 316 having a first type and a second cluster 316 having a second type, where the first type differs from the second type.

In some implementations, the cluster generator 312 performs dimensionality reduction of the example data 308 to determine the clusters 316 (e.g., to generate the plurality of clusters). For example, the example data 308 (e.g., sensor data of the example data 308) can be indicative of a plurality of dimensions of features, such as 1024 dimensions. The dimensions can represent the complexity of the waveforms of the example data 308, such as a number of distinct characteristics of the samples represented by the waveforms (e.g., by amplitude of the waveforms over time), which can be a relatively large number, such as on the order of hundreds or thousands. The cluster generator 312 can process the example data 308 to convert the example data 308 into data of a reduced number of dimensions of features (where at least a portion of the features of the reduced number of dimensions of features can be different than those of the example data 308). In some implementations, the reduced number of dimensions is greater than or equal to 1 and less than or equal to about 10 and may be any integer therebetween. A representation of the example data 308 in the low-dimensional space can correspond to a graph or a histogram, for example.

In some implementations, the cluster generator 312 performs dimensionality reduction by determining a distance between each pair of waveforms of the example data 308, and assigning the example data 308 to points in a low-dimensional (e.g., two-dimensional) space based on the determined distances, such that points for example data 308 having lesser distances are arranged closer in the two-dimensional space. In some implementations, the cluster generator 312 determines the distance between two waveforms of the example data 308 as an area between the two waveforms. The cluster generator 312 can determine the clusters based on the locations of the points of the example data 308 in the two-dimensional space and one or more criteria for the clustering, such as a target size for the clusters 316 (e.g., number of elements of example data 308 per cluster and/or radius (e.g., average, median, etc.) of the clusters 316).

The cluster generator 312 can perform a UMAP operation to perform the dimensionality reduction for determining the clusters 316 from the example data 308. For example, the cluster generator 312 can determine a k-nearest neighbor (kNN) graph representation of the example data 308 according to the distances amongst the pairs of example data 308, in which each element of example data 308 is assigned to a point in a low-dimensional (e.g., two-dimensional space), and can have one or more neighbors (e.g., k neighbors) corresponding to the determined distances. The cluster generator 312 can iteratively update the graph representation, e.g., update locations of the example data 308 in the two-dimensional space, until a convergence criterion is achieved.

The cluster generator 312 can perform PCA to perform the dimensionality reduction for determining the clusters 316 from the example data 308. The cluster generator 312 can perform PCA to map the high-dimensional data of the example data 308 to a selected number of dimensions, e.g., two dimensions. This can be useful for clustering the example data 308, as the PCA operation can extract useful signal information for classification from the example data 308 into a relatively low number of dimensions.

In some implementations, the cluster generator 312 performs t-SNE to perform the dimensionality reduction for determining the clusters 316 from the example data 308. For example, the cluster generator 312 can determine a probability distribution over pairs of the example data 308 such as example data 308 that are similar are assigned a higher probability while example data 308 that are dissimilar are assigned a lower probability. The cluster generator 312 can determine a corresponding probability distribution in a low-dimensional space (e.g., having a number of dimensions that can be predetermined, adapted, and/or learned), and as a convergence criterion can reduce or minimize a difference, such as a Kullback-Leibler divergence (KL divergence), between the two distributions with respect to the locations of the example data 308 in the dimensional spaces.

In some implementations, the cluster generator 312 includes an autoencoder to perform the dimensionality reduction. For example, the autoencoder can include an encoder to encode the example data 308 into a latent space (which can have a predetermined and/or selected number of dimensions) and a decoder to process the encoded example data 308 from the latent space into the original dimensional space of the example data 308. The autoencoder can be a pre-trained (i.e., trained in advance) machine learning model and/or can be trained or updated based on encoding of example data 308 into the latent space. The cluster generator 312 can determine the clusters 316 in the latent space.

The cluster generator 312 can perform at least a first dimensionality reduction on the example data 308 using a first operation (e.g., PCA), and can perform at least one a second dimensionality reduction (e.g., UMAP) based on the output of the first dimensionality reduction. For example, the cluster generator 312 can perform PCA to pre-process the example data 308 and can concatenate the results of the PCA to the example data 308 for inputting to the UMAP operation.

In some implementations, the cluster generator 312 is configured to perform the dimensionality reduction as a clustering operation on the example data 308. For example, the cluster generator 312 can execute one or more clustering algorithms, including, for example and without limitation, k-means clustering, density-based spatial clustering of applications with noise (DBSCAN), hierarchical clustering, spectral clustering, or various combinations thereof, to cluster the example data 308. In some implementations, the cluster generator 312 receives an instruction for the clustering (e.g., a number of clusters k for k-means clustering) and performs the clustering according to the instruction.

Referring further to FIG. 3, the training system 300 can assign one or more labels (e.g., artificial labels determined based on the clustering, rather than predefined and/or predetermined labels in the data sources 304) to one or more corresponding clusters 316. For example, the training system 300 can assign labels that indicate identifier(s) common to at least a subset of the example data 308 of the one or more corresponding clusters 316. This can include, for example, indicating whether example data 308 correspond to patient samples, or express molecular markers. The labels can include an identifier of the cluster 316 to which the example data 308 is assigned. The labels can include, for example and without limitation, an identifier of a cell type of a cell corresponding to a given element of example data 308, such that the cluster 316 to which the given element of example data 308 is assigned is labeled with the cell type of the cell.

In some implementations, the training system 300 assigns at least one gate to the clusters 316. For example, the training system 300 can define a region in the low-dimensional space (e.g., a region bounding one or more portions of the low-dimensional space) in which each example data 308 of a given cluster 316 is located. The gate can be used as a filter for classification and/or training of classifiers 128. For example, the training system 300 can assign a first classification to the example data 308 of one or more first clusters 316 around which the gate is defined and can assign a second classification different from the first classification to the example data 308 of one or more second clusters 316 outside of the gate. In some implementations, the example data 308 of the one or more first clusters 316 are assigned a first value of a flag to indicate that the example data 308 is in the gate, and the example data 308 of the one or more second clusters are assigned a second value of the flag to indicate that the example data is outside the gate.

The training system 300 can assign a first gate for target data, and a second gate for non-target data. The training system 300 can receive a selection of one or more clusters 316. The training system 300 can receive the selection by various inputs, such as user input. For example, the training system 300 can receive an input indicating the selection of the one or more clusters 316 as a user interface input (e.g., via a mouse or keyboard), such as an input indicating a polygon, circle or a rectangle (i.e., a box) to define the gate (e.g., around the selected clusters 316). This can allow for the classifiers 128 to be targeted towards data and/or classification tasks of interest in a manner responsive to the user input. For example, responsive to detecting the user interface input, the training system 300 can generate the gate to correspond to the region (of the space in which the clusters 316 are defined) defined by the user interface input.

As noted above, inputs in the form of polygons, circles or rectangles (boxes) can be used to define gates in some implementations. However, gating according to certain exemplary implementations is not limited to these particular forms. In some implementations, manual gating can be performed using boundary gates to exclude particular data (e.g., a population) above a specified threshold in one-dimensional or two-dimensional plots. In particular, a boundary gate can be established by selecting an uppermost limit of the gate such that data below the selected boundary is included in a rectangular gate. In some implementations, rectangular gates are employed for data in two-dimensional plots. To establish a rectangular gate, two diagonal points defining the limits of a population can be selected, so as to allow a rectangle to be constructed around the population. In some implementations, a polygonal gate or an ellipsoid (elliptical) gate can be used for populations in two-dimensional plots. In particular, ellipsoid gates can be established around a population by selecting several (e.g., four) points that encompass the population. In some implementations, interval gates are used for gating a population in either one-dimensional or two-dimensional plots between an upper limit and a lower limit. In particular, interval gates can be established by selecting both the lower and upper boundaries of a population and then constructing a rectangular gate around the population. In some implementations, threshold gates can be used to gate a population in one-dimensional or two-dimensional plots that lie above a particular threshold. In contrast to boundary gates, a threshold gate can be established by selecting the lowermost limit of the population to construct a rectangular gate around the population above the threshold. In some implementation, quadrant gates can be used to gate four populations in two-dimensional plots. In some implementations, web gates can be utilized to gate multiple populations around a central location. In some implementations, multiple or mixed gates can be constructed where there are multiple populations. As yet a further example, negated gates can be used to gate populations outside of (i.e., excluded from) a constructed gate. It should be appreciated that the foregoing are merely illustrative examples of potential gating techniques and that other gating techniques may be used in connection with the present disclosure.

The training system 300 can perform supervised learning of the classifier 128 based on the clusters 316 and the labels assigned to the clusters 316, such as to generate a trained classifier 128. As such, the training system 300 can facilitate training of the classifier 128 based on the clustering performed by the cluster generator 312, rather than predetermined labels assigned to the example data 308. The classifier 128 can be implemented using any of various machine learning models useful for classification. The classifier 128 can include neural-network based classifiers.

For example, the training system 300 can apply the example data 308 as input to the classifier 128 to cause the classifier 128 to generate candidate outputs, can compare the candidate outputs with at least one of the clusters 316 or the labels, and can update the classifier 128, such as by updating one or more parameters of the classifier 128 (e.g., weights, biases, coefficients, machine learning model architecture structures) based on the comparison. The training system 300 can iteratively perform inputting of the example data 308 to the classifier 128 and updating of the classifier 128 based on the comparisons of the candidate outputs with the at least one of the clusters 316 or the labels until one or more convergence criteria are achieved (e.g., using an optimization function, including but not limited to gradient descent).

In some implementations, the classifier 128 includes at least one support vector machine (SVM). The SVM can be useful for the classification of sensor data 112 due to its effectiveness in handling the dimensionality of the sensor data 112, while avoiding overfitting. The SVM can include one or more hyperplanes that separate the example data 308 in a manner representative of the clusters 316, so that the SVM (e.g., the hyperplanes of the SVM) can receive new data inputs (e.g., sensor data 112) and classify the new data inputs according to the one or more hyperplanes. For example, the training system 300 can train the SVM to determine the one or more hyperplanes to achieve at least one criterion (e.g., maximize or optimize) the positioning of the one or more hyperplanes relative to the clusters 316. For example, the training system 300 can train the SVM by applying the example data 308 as input to the SVM. The inputting of the example data 308 can cause the SVM to (i) determine one or more candidate hyperplanes, (ii) evaluate an objective function for the one or more candidate hyperplanes (e.g., based on determination of distances between the one or more candidate hyperplanes and the clusters 316 (e.g., the example data 308 of respective clusters)), and (iii) update one or more parameters (e.g., weights) of the one or more candidate hyperplanes to achieve one or more convergence criteria.

The classifier 128 can include at least one regression function, such as a logistic regression function. Implementing the classifier 128 as a regression function can be useful for classification of sensor data 112 due to the efficiency of training the regression function, and the speed of the regression function in processing new sensor data 112. The training system 300 can train the logistic regression function by applying the example data 308 as input to the logistic regression function, causing the logistic regression function to generate one or more candidate outputs (expected to be representative of whether the example data 308 belong to given clusters 316), evaluating an objective function, such as a cost function, based on the candidate outputs and the assignments of example data 308 to clusters 316, and updating parameters of the logistic regression function according to the evaluation.

In some implementations, the classifier 128 can include at least one decision tree. The decision tree can be useful for processing of sensor data 112 due to the interpretability of the decision tree, e.g., the structure of the decision tree identifying the classifications for the sensor data 112. The training system 300 can train the decision tree using any of various decision tree algorithms, to cause the decision tree to have a structure in which features of the example data 308 are used to define branches from a root node to various leaf nodes, the leaf nodes being representative of the classification of the example data 308 (e.g., to which cluster 316 the example data 308 belong).

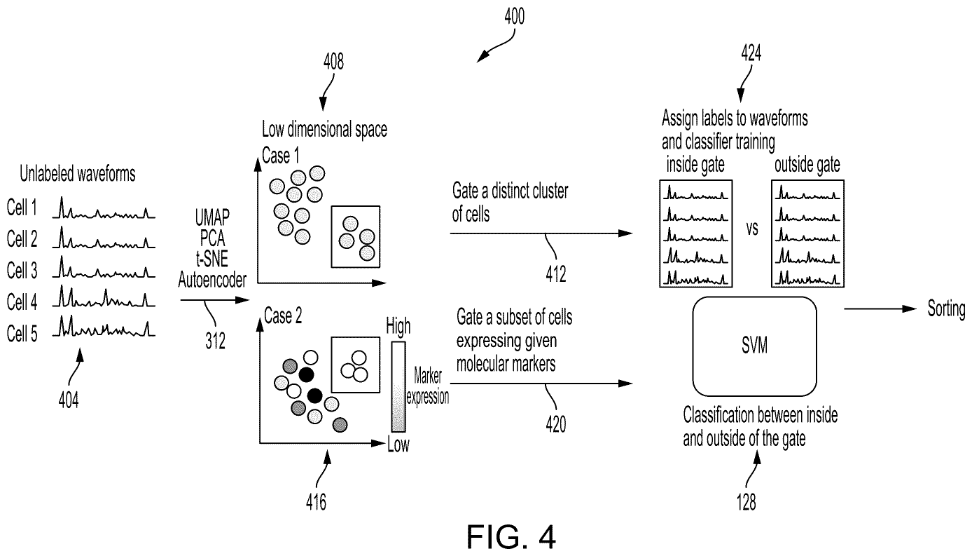

FIG. 4 depicts an example of a process 400 that the training system 300 can perform. As depicted in FIG. 4, unlabeled waveforms 404 can be provided as input to the cluster generator 312 (e.g., as depicted, any one or more of UMAP, PCA, t-SNE, and/or autoencoder), which can perform dimensionality reduction to assign the waveforms 404 to locations in one or more low-dimensional spaces, such as a first space 408 for which the training system 300 performs gating 412 according to the locations of the waveforms 404 and a feature of a selected cluster of waveforms 404 (e.g., belonging to patient samples) and/or a second space 416 for which the training system 300 performs gating 420 according to the locations of the waveforms 404 and molecular marker expression. For example, gating can be performed for a distinct cluster of cells that is a cluster appearing only in patient samples. The training system 300 can assign labels 424 to the waveforms 404 based on the respective gating 412, 420, and can train the classifier 128 (e.g., as depicted, an SVM) using the waveforms 404 and the assigned labels 424. The training system 300 can perform the gating 412 and/or gating 420 according to an input indicating features of the waveforms 404 to include inside the gates or outside of the gates.

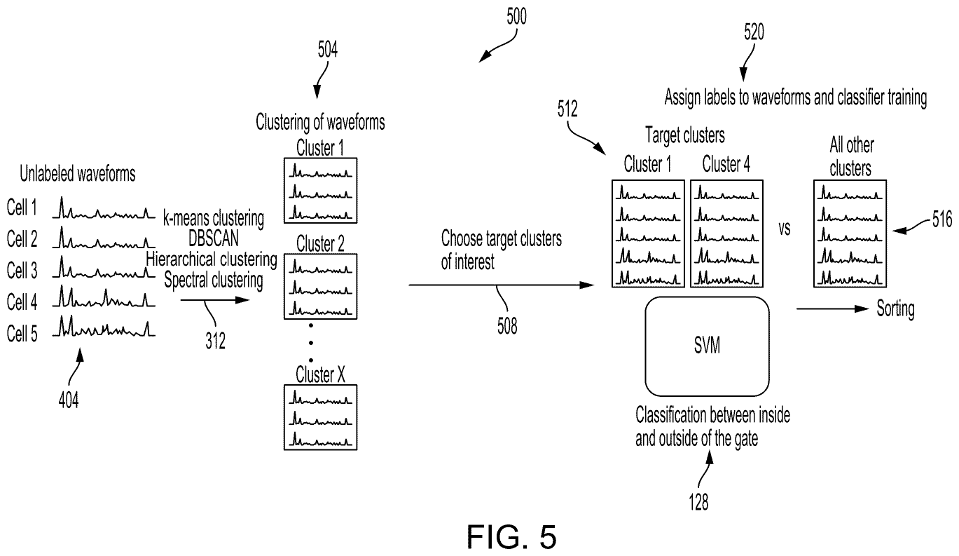

FIG. 5 depicts an example of a process 500 that the training system 300 can perform. As depicted in FIG. 5, unlabeled waveforms 404 can be provided as input to the cluster generator 312 (e.g. and without limitation, as depicted, the cluster generator 312 can execute any one or more of k-means clustering, DBSCAN, hierarchical clustering, and/or spectral clustering), which can cluster the waveforms 404 to assign the waveforms 404 to respective clusters 504. The training system 300 can perform a selection 508 of one or more first clusters 504 as target clusters 512 and one or more second clusters 504 as non-target (e.g., other) clusters 516. The training system 300 can assign labels 520 to the respective waveforms 404 based on the corresponding clusters 512, 516, and can train the classifier 128 (e.g., as depicted, an SVM) using the waveforms 404 and the assigned labels 520. The training system 300 can perform the selection 508 according to an input indicating features of the target cluster(s) 512.

Referring further to FIGS. 1 and 3, in some implementations, the classifier 128 is a pre-trained machine learning model. For example, the classifier 128 can be trained (e.g., as described with reference to FIG. 3) in a first one or more operations prior to processing of the sensor data 112 to generate the classification 132 in a second one or more operations. The classification circuit 116 (e.g., the memory 124) can receive the classifier 128 as a machine learning model data structure or can receive one or more parameters of the classifier 128 (e.g., weights, biases, information indicative of structures of the classifier 128). Additionally, the classification circuit 116 can update a baseline model based on the received one or more parameters. The pre-training of the classifier 128 can allow for separate processes and/or separated workflows for training of the classifier 128 and execution of the classifier 128, such as to allow for different data and/or sensors to be used for the training relative to the classification.

In some implementations, the classifier 128 is trained and/or updated using the sensor data 112. For example, sensor data 112 regarding a plurality of objects 104 can be obtained, e.g., by being retrieved from a source. In particular, the sensor data 112 can be retrieved and can be processed using the training system 300 to train the classifier 128. Responsive to being trained, the classifier 128 can output classifications 132 of the plurality of objects 104. This can allow for an end-to-end classification of sensor data 112 regarding the plurality of objects 104, such as to distinguish target objects amongst observed objects in a batch of objects 104. In some implementations, the classification circuit 120 can receive identifiers for the classifications 132 (e.g., via a user interface) to assign to the classifications 132.

### Operation of Machine Learning-Based Classifiers

Referring further to FIG. 1, the classifier 128 can be used to determine one or more classifications regarding the one or more objects 104 for which the sensor 108 obtains sensor data 112. For example, the classifier 128 can implement a sorting function to sort target cells from others based on classification results. As discussed above, due to the manner in which the classifier 128 is trained, the classifier 128 can perform classification based on features of the target cells even where labels for supervised training are not available.

The classifier 128 can receive sensor data 112 from the sensor 108 (e.g., the sensor system 100 can apply the sensor data 112 as input to the classifier 128). For example, the sensor 108 can output the sensor data 112 as one or more waveforms (or images, such as cell images) corresponding to one or more objects 104 for which the sensor data 112 is obtained. The sensor data 112 can include the waveforms and can include identifiers of the objects 104. The sensor data 112 can be received by the classifier 128 periodically as outputted from sensor and/or can be retrieved (e.g., in single instances of sensor data 112 or in batches) from the sensor 108 or a data source coupled with the sensor 108. For example, the sensor 108 can be communicatively coupled to a data source from which the sensor 108 is configured to acquire data, e.g., at single instances or intervals.

The classifier 128, responsive to receiving the sensor data 112, can determine the classification of the one or more objects 104. For example, having been trained using the example data 308 and clusters 316 from dimensionality reduction and/or clustering of the example data 308, the classifier 128 can be capable of processing the sensor data 112 to determine (e.g., predict) the classification for the one or more objects 104. In some implementations, the classifier 128 performs the classification on raw data, such as raw waveforms or images. In some implementations, the classifier 128 performs the classification on reduced dimension data. For example, the classifier 128 can process the sensor data in a variable space corresponding to a number of dimensions of the dimensionality reduction, the number of dimensions being greater than or equal to one (e.g., a histogram of sensor data 112) and less than or equal to about ten. The classifier 128 can include or be configured based on one or more gates that distinguish the clusters 316. For example, the classifier 128 can detect the classification 132 of the one or more objects 104 based on a gate distinguishing a first cluster 316 of the plurality of clusters that is associated with the classification 132 (e.g., the first cluster 316 is inside the gate) from a second cluster 316 of the plurality of clusters that is unassociated with the classification 132 (e.g., the second cluster 316 is outside of the gate).

The classifier 128 can output the classification 132 in various formats. For example, the classifier 128 can assign the classification 132 to a data structure that includes the sensor data 112. The classifier 128 can transmit the classification 132 and/or the data structure to a remote device. The classifier 128 can cause a user interface (e.g., a display) to present an indication of the classification 132. The classifier 128 can receive user inputs for operation by way of the user interface (e.g. and without limitation, via a keyboard, mouse, touchscreen, camera, and/or audio input device), such as for defining gates, selection of target cluster(s), and/or causing sorting of cells based on the selection of target cluster(s). The system 100 can present information regarding the operation of the classifier 128 based on inputs received via the user interface. For example, the system 100 can present information regarding the operation of the classifier 128 responsive to selection of a given cluster, the system 100 can present information regarding the given cluster, such as location, shading or color on a heatmap representation of the clusters.

### Examples

The following non-limiting example indicate classification tasks performed using one or more systems described, such as to train and execute the classifier 128, as well as the performance of the classifier 128 on such tasks.

### Bead Sorting

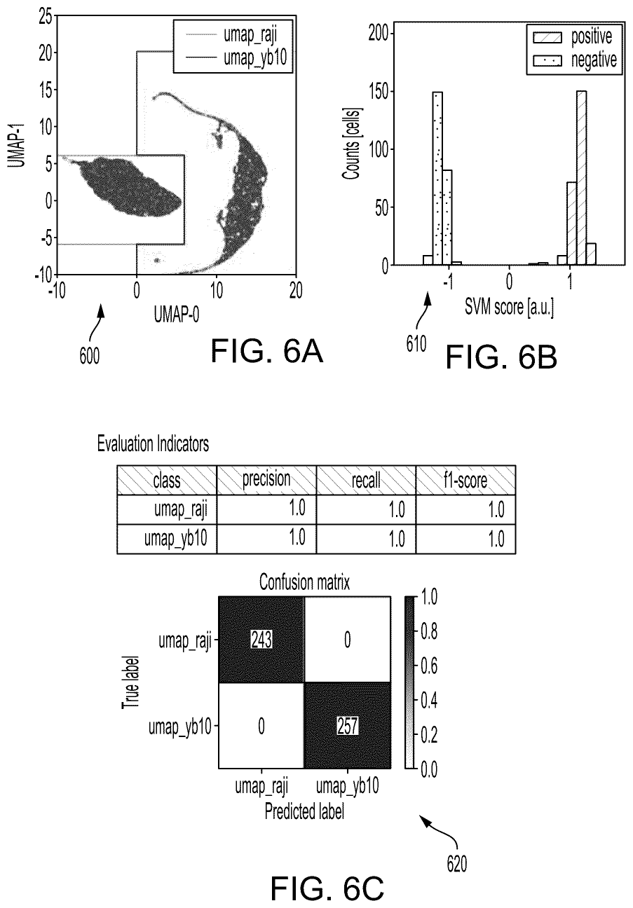

A classifier was used to perform classification to sort yellow beads (as target objects) amongst fixed cells. The classifier was trained based on GMI waveforms of the objects. The GMI waveforms were pre-processed using PCA, the output of which was concatenated to the GMI waveforms to provide as input to UMAP. FIG. 6A depicts in chart 600 the gating of the yellow bead (umap_yb10) objects relative to the fixed cell (umap_raji) in a two-dimensional UMAP space. The classifier was implemented as an SVM that was trained from the gating showing by the chart 600, with SVM scores (the distance of individual data points from the decision boundary of the classifier) shown in chart 610 of FIG. 6B. The perform of the classifier was validated based on performance scores shown in chart 620 of FIG. 6C, including precision, recall, and f1-scores of 1.0 for each class, and shown in the confusion matrix where each object's predicted class matched its true label. Upon execution of the classifier on sensor data for new objects, the classifier was able to perform sorting with purity of 99.9%, sorting recovery of 98.8%, coincidence of 2.2%, and throughput of 250 episodes per second.

### Monocyte Isolation in White Blood Cells

A classifier was used to perform sorting of monocytes amongst white blood cells (WBCs). The input sample was WBCs isolated from fresh blood samples of healthy volunteers. The input sample included monocyte and other white blood cell types. Antibody staining was performed with CD14 (monocyte marker) and CD45 (lymphocyte marker) for validation. GMI waveforms of input samples were measured with Ghost Cytometry.

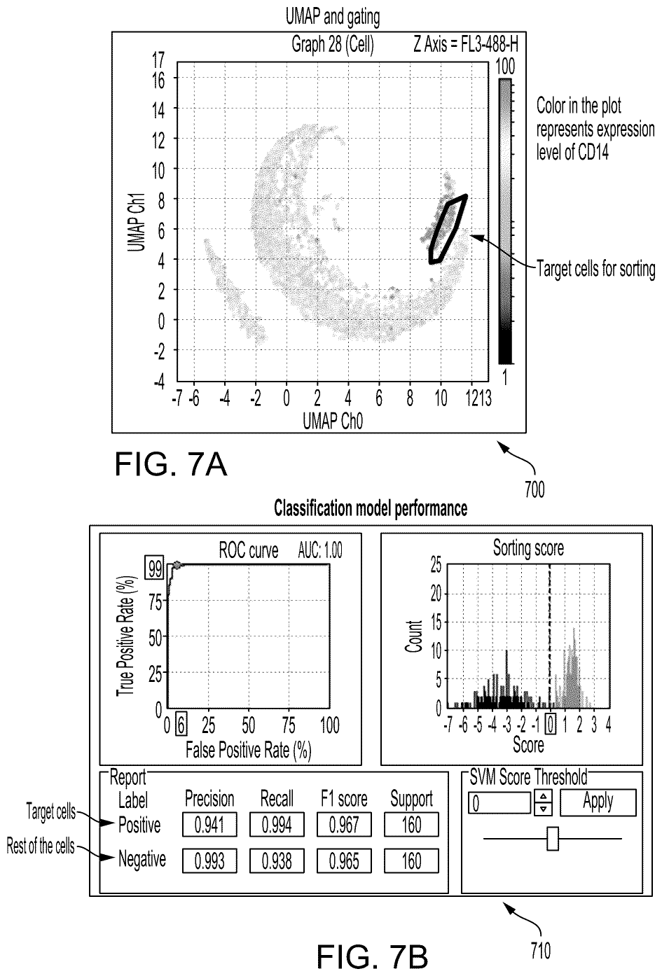

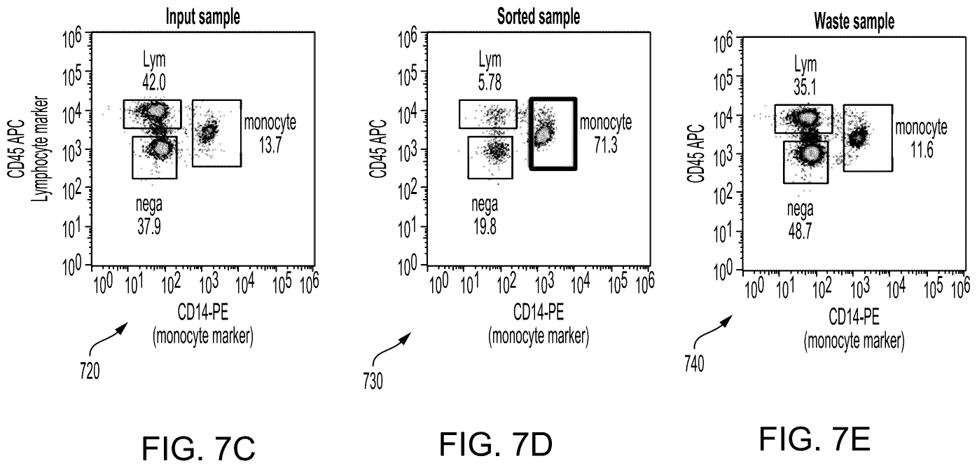

Dimensionality reduction of the GMI waveforms was performed with UMAP. Target cells were defined on the basis of location in the low dimensional space, e.g., using a gate as depicted in chart 700 of FIG. 7A. The sorting was performed based on the classification model implemented on FPGA. The classification model was implemented as an SVM, with 640 cells per class for training the model, and 160 cells per class for testing the model. Back scattering ghost motion imaging (bsGMI) and bright field ghost motion imaging (bfGMI) were used for UMAP and classification model training. The performance of the classification model was determined as: roc-auc=1.00, and as shown in chart 710 of FIG. 7B.

Sorting was performed using the trained classification model. For the validation of sorting results, the fraction of monocytes in input samples, sorted samples (cells classified as the target), and wasted samples (cells classified as the non-target cells) were compared using a flow cytometer. CD14 expression level was used for validation (CD14 high: Monocytes; CD14 low: Other cells). The performance was demonstrated by the fraction of monocytes (CD14 high cells) in the input samples being 13.7%, in the sorted samples being 71.3%, and in the waste samples being 11.6%. Charts 720, 730, and 740 of FIGS. 7C-7E demonstrate these values.

Isolation of Disease Specific Cell Population from Acute Lymphoblastic Leukemia Patients

A classifier was used to perform sorting of disease specific cells from cells of patients having acute lymphoblastic leukemia (ALL). Blood samples from ALL patients of contains abnormal cells (blasts) which do not exist in samples from healthy donors. UMAP sorting was used to isolate abnormal cells in peripheral blood mononuclear cells (PBMCs) of ALL patients.

Commercially available frozen PBMCs from healthy donors and ALL patients were used. PBMCs from ALL patients and healthy donors were mixed together after staining cell membranes with different colors (PKH26 (red) for ALL, PKH67 (green) for healthy). Antibody staining was performed with CD45 for validation. GMI waveforms of input samples were measured with ghost cytometry.

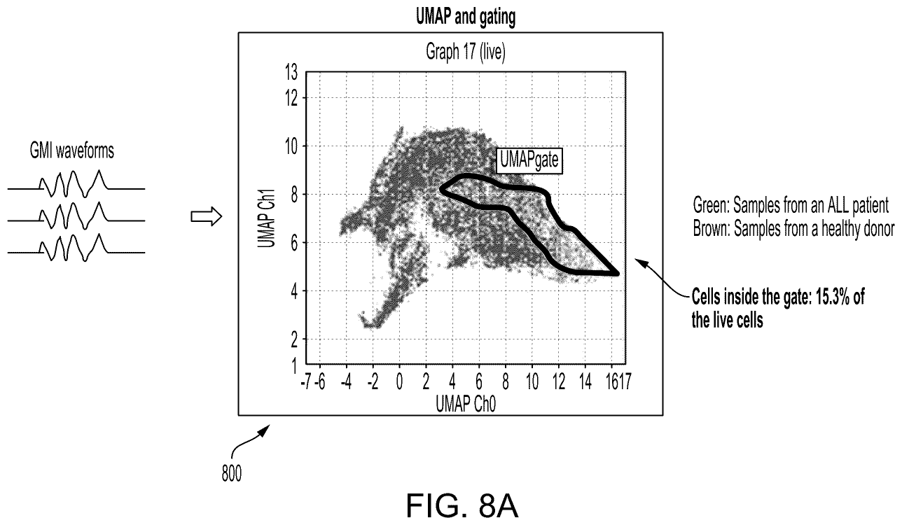

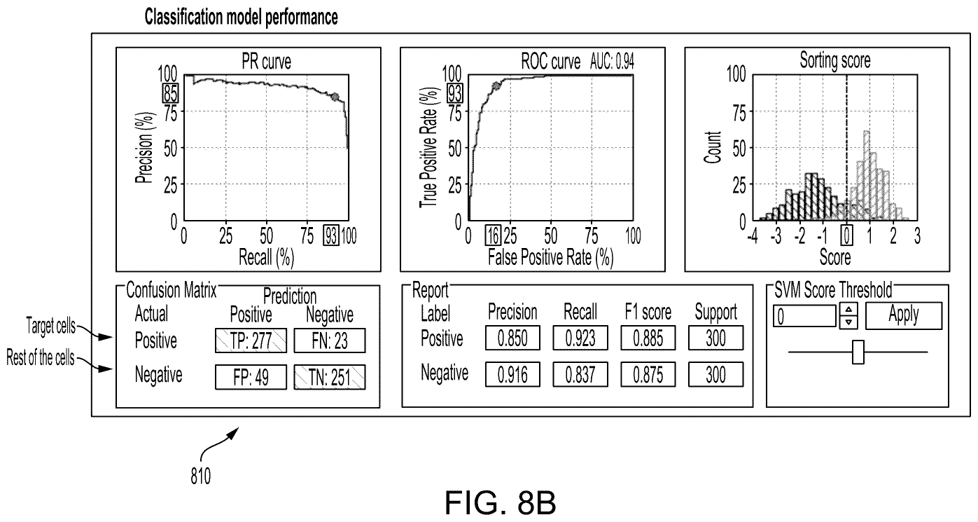

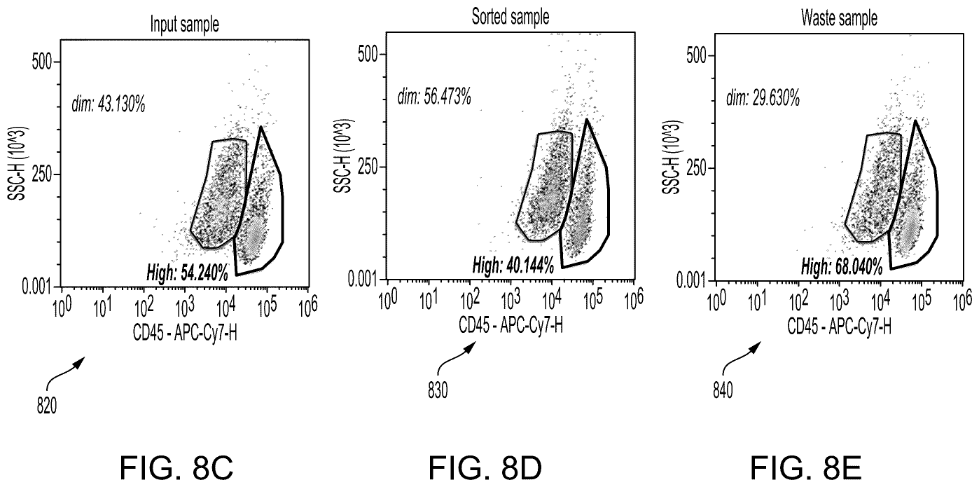

Dimensionality reduction of GMI waveforms was performed with UMAP. Target cells were defined on the basis of location in the low dimensional space. The target gate was assigned to the region where cells from all patients are enriched, as depicted in chart 800 of FIG. 8A.

Sorting was based on a classification model implemented on FPGA. The classification model was configured to classify target cells and the rest of cells in the sample. An SVM was used as the classification model. Twelve-hundred (1200) cells per class were used for training the model, and 300 cells per class were used for testing the model. Forward scattering ghost motion imaging (fsGMI) and back scattering (bsGMI) were used for UMAP and classification model training. The performance of the classification model was determined as: roc-auc=0.94. Charts 810 of FIG. 8B demonstrate the classification performance of the classification model.

For the validation of sorting results, the fraction of blasts in input samples, sorted samples (cells classified as the target), and wasted samples (cells classified as the non-target cells) were compared using a flow cytometer. The CD45 expression level was used for validation, where CD45 high corresponds to normal lymphocytes, and CD45 dim corresponds to blast cells (abnormal cells). The fraction of monocytes (CD45 dim cells) were found to be, in the input samples (ALL PBMC): 43.1%; in the sorted samples: 56.5%; and in the waste samples: 29.6%, as shown in charts 820, 830, and 840 of FIGS. 8C, 8D and 8E.

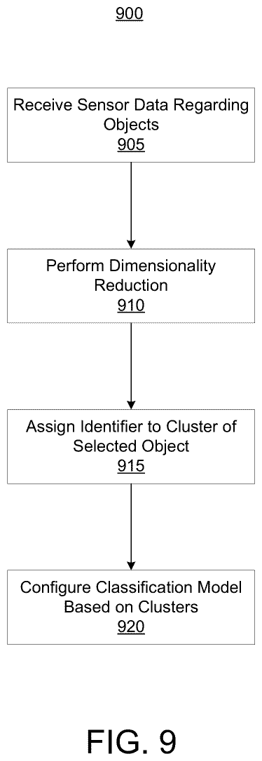

FIG. 9 depicts an example of a method 900 for training of a machine learning model-based classifier for object classification. The method 900 can be performed using one or more systems described herein, such as the training system 300. Various aspects of the method 900 can be performed in end-to-end processes and/or separated or batched processes, including by the same or different devices. For example, the method 900 can be used to perform initial training, pre-training, and/or updating of machine learning-based classification models.

At 905, a plurality of sensor data representations of a plurality of objects can be received by one or more processors. The sensor data representations can be waveforms, such as waveforms outputted by a cytometer. The sensor data representations can be fluorescent data signals. The sensor data representations can be images. The sensor data representations can be histograms. The plurality of objects can include at least one of cellular material, nucleic acid material, biological material, or chemical material. The one or more processors can be implemented using any of various hardware devices. In some implementations, an FPGA includes the one or more processors, such as to facilitate instantaneous, real-time, and/or near real-time processing of the sensor data.

At 910, dimensionality reduction of the sensor data representations can be performed. The dimensionality reduction can include processing the sensor data representations using UMAP, PCA, t-SNE, and/or autoencoding (e.g., applying the plurality of sensor data representations to a dimensionality reduction process). The dimensionality reduction can include clustering the sensor data representations (e.g., to reduce dimensionality of the sensor data representations from raw data dimensions to clusters in a reduced number of dimensions, such as by applying the plurality of sensor data representations as input to a clustering process). The dimensionality reduction can be performed as unsupervised learning, such as without the use of labels of the sensor data representation (e.g., without any identifier of types of the plurality of objects). The clusters can be associated with different types of objects (e.g., a first cluster associated with a first type and a second cluster associated with a second type). The dimensionality reduction can be performed on a first subset (e.g., training set) of the sensor data representations. The dimensionality reduction can be performed to assign each object of the plurality of objects to a corresponding cluster of the (plurality of) clusters.

At 915, an identifier of a type of a given object of the plurality of objects can be assigned to a cluster (and/or a gate) to which the given object is assigned. The identifier can be different than a label for the given object. The identifier can identify at least one source of the object (e.g., from a patient or not). Assigning the identifier can include selecting the cluster as a target cluster for sorting.

At 920, a classification model, such as a machine learning-based classification model, can be configured using the clusters (and/or gates). For example, the sensor data representations can be provided as input to the classification model, and the classification model can be updated based on evaluation of candidate outputs generated responsive to the inputs and the clusters and/or gates, such as to cause the classification model to be capable of sorting sensor data in a manner analogous to the clusters. The classification model can be validated using a second subset (e.g., test and/or validation subset) of the sensor data representations.

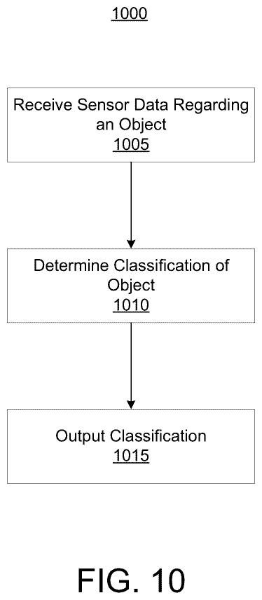

FIG. 10 depicts an example of a method 1000 for deploying a classification model for object classification. The method 1000 can be performed using various systems described herein, including but not limited to the sensor system 100 and/or classification circuit 116. The method 1000 can be performed responsive to the configuration of the classification model trained as described with respect to FIG. 9. The method 1000 can be performed by hardware of the sensor system 100 (e.g., by a circuit of the sensor 108) and/or remote from the sensor system 100. The method 1000 can be performed in synchronous/real-time operations or can be performed asynchronously. For example, the method 1000 can be performed responsive to receiving outputs from the sensor 108 or can be performed on stored outputs from the sensor 108. In particular, the method 1000 can be performed on batches of stored outputs from the sensor 108.

At 1005, sensor data regarding an object can be received. The sensor data can be received from a flow cytometer, a photosensor/photodetector, or an image capture device. The sensor data can be received by being retrieved from a data source remote from the flow cytometer, photosensor/photodetector, or image capture device. The sensor data can include data structures and/or electrical signals representative of waveforms, such as GMI waveforms, image data, fluorescence data, or various combinations thereof.

At 1010, the sensor data can be applied as input to a classification model, such as a machine learning-based classification model. The classification model can include, for example, an SVM, a decision tree, or a logistic regression function. The classification model can be configured based on training data that includes a plurality of clusters generated by dimensionality reduction of example data regarding example objects. Responsive to receiving the sensor data, the classification model can determine a classification of the object, where the classification can correspond to at least one of a corresponding cluster of the plurality of clusters or an identifier assigned to the cluster.

At 1015, the classification can be outputted. For example, the classification can be stored in a data structure, which can also include at least one of the sensor data or an identifier of the object. The data structure can be transmitted to a remote device. The classification can be presented by a user interface (e.g., in graphical or tabular form, via one or more display screens).

### Exemplary Computer Implementations

The present disclosure provides computer systems that are programmed to implement methods and systems of the disclosure. FIG. 12 shows a computer system 1301 that includes a central processing unit (CPU, also “processor” and “computer processor” herein) 1305, which can be a single core or multi core processor, or a plurality of processors for parallel processing. The computer system 1301 also includes memory or memory location 1310 (e.g., random-access memory, read-only memory, flash memory), electronic storage unit 1315 (e.g., hard disk), communication interface 1320 (e.g., network adapter) for communicating with one or more other systems, and peripheral devices 1325, such as cache, other memory, data storage and/or electronic display adapters. The computer system 1301 can include or be in communication with an electronic display 1335 that comprises a user interface (UI) 1340 for providing, for example, information to a user. Examples of user interfaces include, without limitation, a graphical user interface (GUI) and web-based user interface.

The memory 1310, storage unit 1315, interface 1320 and peripheral devices 1325 are in communication with the CPU 1305 through a communication bus (solid lines), such as a motherboard. The storage unit 1315 can be a data storage unit (or data repository) for storing data. The computer system 1301 can be operatively coupled to a computer network (“network”) 1330 with the aid of the communication interface 1320. The network 1330 can be the Internet, an internet and/or extranet, or an intranet and/or extranet that is in communication with the Internet. The network 1330 in some cases is a telecommunication and/or data network. The network 1330 can include one or more computer servers, which can enable distributed computing, such as cloud computing. The network 1330, in some cases with the aid of the computer system 1301, can implement a peer-to-peer network, which may enable devices coupled to the computer system 1301 to behave as a client or a server.

The CPU 1305 can execute a sequence of machine-readable instructions, which can be embodied in a program or software. The instructions may be stored in a memory location, such as the memory 1310. The instructions can be directed to the CPU 1305, which can subsequently program or otherwise configure the CPU 1305 to implement methods of the present disclosure.

Examples of operations performed by the CPU 1305 can include fetch, decode, execute, and writeback.

The CPU 1305 can be part of a circuit, such as an integrated circuit. One or more other components of the system 1301 can be included in the circuit. In some cases, the circuit is an application specific integrated circuit (ASIC).

The storage unit 1315 can store files, such as drivers, libraries and saved programs. The storage unit 1315 can store user data, e.g., user preferences and user programs. The computer system 1301 in some cases can include one or more additional data storage units that are external to the computer system 1301, such as located on a remote server that is in communication with the computer system 1301 through an intranet or the Internet.

The computer system 1301 can communicate with one or more remote computer systems through the network 1330. For instance, the computer system 1301 can communicate with a remote computer system of a user. Examples of remote computer systems include personal computers (e.g., portable PC), slate or tablet PC's (e.g., Apple® iPad, Samsung® Galaxy Tab), telephones, smart phones (e.g., Apple® iphone, Android-enabled devices, Blackberry®), or personal digital assistants. The user can access the computer system 1301 via the network 1330.

Methods as described herein (such as one or more methods for particle analysis, image-free optical methods, or methods for identifying one or more target cells from a plurality of cells, as described herein) can be implemented by way of machine executable code (e.g., where the machine is at least one computer processor, at least one microprocessor) stored on an electronic storage location of the computer system 1301, such as, for example, on the memory 1310 or electronic storage unit 1315. The machine executable or machine readable code can be provided in the form of software.

During use, the code can be executed by the processor 1305. In some cases, the code can be retrieved from the storage unit 1315 and stored on the memory 1310 for ready access by the processor 1305. In some situations, the electronic storage unit 1315 can be precluded, and machine-executable instructions are stored on memory 1310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

### Definitions

Having described certain illustrative implementations, it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

Various numerical values herein are provided for reference purposes only. Unless otherwise indicated, all numbers expressing quantities of properties, parameters, conditions, and so forth, used in the specification and claims are to be understood as being modified in all instances by the term “about” or “approximately.” Accordingly, unless indicated to the contrary, the numerical parameters set forth in the following specification are approximations. Any numerical parameter should at least be construed in light of the number of reported significant digits and by applying ordinary rounding techniques. The term “about” or “approximately” when used before a numerical designation, e.g., a quantity and/or an amount including ranges, indicates approximations which may vary by +10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The term “coupled” and variations thereof includes the joining of two members directly or indirectly to one another. Such joining may be stationary or moveable. Such joining may be achieved with the two members coupled directly with or to each other, or with the two members coupled with each other using an intervening member. Such coupling may be mechanical, electrical, or fluidic.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions. Any processing may be carried out by one or more computers, microcomputers, controllers, microcontrollers, processors and/or microprocessors, that may be provided centrally or in a distributed manner, where the processing can be carried out individually or collectively by a plurality of the computers, microcomputers, controllers, microcontrollers, processors and/or microprocessors.

Although the figures show a specific order of method steps, the order of the steps may differ from what is depicted. Also two or more steps may be performed concurrently or with partial concurrence. Such variation will depend on the software and hardware systems chosen and on design considerations. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular computing structure or portion thereof. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

References to “or” may be construed as inclusive so that any terms described using “or” may indicate any of a single, more than one, and all of the described terms. References to at least one conjunctive list of terms may be construed as an inclusive OR to indicate any of a single, more than one, and all of the described terms. For example, a reference to “at least one of ‘A’ and ‘B”’ can include only ‘A’, only ‘B’, as well as both ‘A’ and ‘B’. Such references used in conjunction with “comprising” or other open terminology can include additional items.

Modifications of described elements and acts such as variations in values of parameters or variations in arrangements can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The scope of the systems and methods described herein is indicated by the appended claims, rather than the foregoing description, and variations that come within the meaning and range of equivalency of the claims are embraced therein.

What is claimed is:

1. A system, comprising:
one or more processors configured to:
retrieve sensor data regarding an object; and
apply the sensor data as input to a classification model to cause the classification model to determine a classification of the object, the classification model configured based on training data comprising a plurality of clusters generated by dimensionality reduction of example data regarding example objects, at least one cluster of the plurality of clusters associated with the classification; and
output the classification of the object.

2. The system of claim 1, wherein the classification model is configured to process the sensor data in a variable space corresponding to a number of dimensions of the dimensionality reduction, the number of dimensions greater than or equal to one and less than or equal to about ten.

3. The system of claim 1, wherein the one or more processors are configured to perform the dimensionality reduction as a clustering operation on the example data to generate the plurality of clusters.

4. The system of claim 1, wherein the one or more processors are configured to generate the plurality of clusters without predetermined labels of the example data.

5. The system of claim 1, wherein the sensor data and the example data each respectively comprise a time-series electrical signal representative of an electromagnetic wave detected regarding the respective object and example objects.

6. The system of claim 1, wherein the object comprises at least one of cellular material, nucleic acid material, biological material, or chemical material.

7. The system of claim 1, wherein the object comprises a cell, and the classification model is configured to detect the classification of the cell based on a gate distinguishing a first cluster of the plurality of clusters that is associated with the classification from a second cluster of the plurality of clusters that is unassociated with the classification.

8. The system of claim 1, wherein a field programmable gate array (FPGA) comprises the one or more processors, the FPGA configured to receive the sensor data from a flow cytometer through which the object is flowed, wherein the flow cytometer is configured to operate in a fluorescent activated cell sorting (FACS) mode or a structured light mode to output a waveform representing the sensor data regarding the object.

9. The system of claim 1, wherein the object comprises a cell, and the classification indicates a cell type of the cell.

10. A system, comprising:
a flow cytometer configured to direct a fluid flow comprising an object through a field of view of a photosensor and cause the photosensor to detect sensor data regarding the object; and
one or more processors configured to apply the sensor data as input to a classification model to cause the classification model to detect a classification of the object, the classification model configured based on training data comprising a plurality of clusters generated by dimensionality reduction of example data regarding example cells, at least one cluster of the plurality of clusters associated with the classification.

11. The system of claim 10, wherein the one or more processors are configured to perform the dimensionality reduction as a clustering operation on the example data to generate the plurality of clusters.

12. The system of claim 10, wherein the one or more processors are configured to generate the plurality of clusters without predetermined labels of the example data.

13. The system of claim 10, wherein the sensor data and the example data respectively correspond to an electrical signal representative of a waveform regarding the respective object and example objects.

14. The system of claim 10, wherein the one or more processors are configured to use the classification model to detect the classification of the object based on a gate distinguishing a first cluster of the plurality of clusters that is associated with the classification from a second cluster of the plurality of clusters that is unassociated with the classification.

15. The system of claim 10, wherein a field programmable gate array (FPGA) comprises the one or more processors.

16. The system of claim 10, wherein:
the flow cytometer is to operate, to detect the sensor data regarding the object, in one of a fluorescent activated cell sorting (FACS) mode or a structured light mode.

17. A method, comprising:
receiving, by one or more processors, a plurality of sensor data representations of a plurality of objects, wherein the plurality of objects comprise at least one of cellular material, nucleic acid material, biological material, or chemical material;
performing, by the one or more processors, dimensionality reduction of the plurality of sensor data representations to assign each object of the plurality of objects to a corresponding cluster of a plurality of clusters;
assigning, by the one or more processors, an identifier of a type of a given object of the plurality of objects to the corresponding cluster of the plurality of clusters to which the given object is assigned; and
configuring, by the one or more processors, a classification model based on the plurality of clusters and the identifier of the type.

18. The method of claim 17, wherein performing the dimensionality reduction comprises applying the plurality of sensor data representations as input to at least one of a dimensionality reduction process or a clustering process.

19. The method of claim 17, wherein performing the dimensionality reduction operation comprises performing, by the one or more processors, the dimensionality reduction operation without any identifier of types of the plurality of objects.

20. The method of claim 17, wherein the plurality of clusters comprises a first cluster associated with a first type and a second cluster associated with a second type different from the first type.
